(19) United States
(12) Patent Application Publication
(10) Pub. No.: US 2009/0141052 A1
(43) Pub. Date: Jun. 4, 2009

(54) DISPLAY DEVICE, ELECTRONIC APPARATUS, AND IMAGE FORMING METHOD

(75) Inventor: Goro HAMAGISHI, Toyonaka-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/274,062

(22) Filed: Nov. 19, 2008

(30) Foreign Application Priority Data
Nov. 30, 2007 (JP) 2007-310007

(51) Int. Cl. G09G 5/02; G09G 5/00

(52) U.S. Cl. 345/694; 345/1.1

(57) ABSTRACT

A display unit has subpixels arranged in a row direction and an intersecting column direction. A light-shielding member is arranged to overlap every other boundary of the subpixels arranged in the row direction in front view. An image data synthesis circuit generates image data of a composite image to be displayed on a part of the display unit based on first and second images. Each of the subpixels forms either a first or second subpixel alternately arranged in the row direction. The first subpixel and the second subpixel are arranged at adjacent positions on opposite sides of the light-shielding member in front view. In the part of the display unit, the first and second subpixels display, respectively, the first and second images on the basis of image data of the composite image. In another part of the display unit, the first and second subpixels display a third image.

### BACKGROUND

1. Technical Field

The present invention relates to a display device, an electronic apparatus, and an image forming method.

2. Related Art

A display device is known that is capable of performing directional display of a plurality of different images (for example, first and second images) within different ranges by superimposing a light-shielding member having openings on a surface of a display unit (Japanese Patent No. 3096613). This uses a phenomenon that different pixels are masked (shielded) in accordance with a visual angle by the light-shielding member, in order words, light from different pixels is visible through the openings in accordance with the visual angle.

With the display device that is capable of performing directional display, for example, different persons can simultaneously view the first and second images. Alternatively, if light forming the first image and light forming the second image are incident on the left and right eyes, respectively, it is possible to perform stereoscopic display.

In such a display device, in terms of improvement in visual effect, display performed with a mixture of non-directional display and directional display in a single display unit is demanded. Such display may be performed by physically disabling some of the optical operations of the light-shielding member. For example, JP-A-9-102969 discloses a display device that is capable of performing display with a two-dimensional image (non-directional display) and a three-dimensional image (directional display) that are mixed by arranging a diffusion sheet for partially turning on/off a diffusion effect on an observation side of a display unit and disabling some of the optical operations of the light-shielding member.

As described above, in order to physically disable the optical operations of the light-shielding member, a mechanism for physically disabling the optical operations of the light-shielding member or a circuit for controlling the mechanism needs to be additionally provided. For this reason, the display device may become complicated or may be increased in size.

### SUMMARY

The invention may be embodied as the following aspects.

According to an aspect of the invention, a display device includes a display unit that has a plurality of subpixels arranged in a row direction and a column direction intersecting the row direction; a light-shielding member that is arranged so as to overlap every other boundary of the plurality of subpixels arranged in the row direction in front view; and an image data synthesis circuit that synthesizes image data of a first image and image data of a second image to generate image data of a composite image to be displayed on a part of the display unit. Each of the subpixels forms one of a first subpixel and a second subpixel alternately arranged in the row direction. The first subpixel is arranged at a position adjacent to one side of the light-shielding member in front view, and the second subpixel is arranged at a position adjacent to the other side of the light-shielding member in front view. In the part of the display unit, the first subpixel displays the first image on the basis of image data of the composite image, and the second subpixel displays the second image on the basis of image data of the composite image. In a region excluding the part of the display unit, the first subpixel and the second subpixel display a third image.

With this configuration, it is possible to generate image data of the composite image for directional display in the part of the display unit on the basis of two different image data (image data of the first image and image data of the second image). In the part of the display unit, display of the first image by the first subpixel and display of the second image by the second subpixel are spatially separated from each other by the light-shielding member. Thus, the first image and the second image are directionally displayed in different directions. Meanwhile, in the region excluding the part of the display unit, both the first subpixel and the second subpixel display the third image, and thus non-directional normal display is performed. As such, according to the above configuration, it is possible to perform directional display only in the part of the display unit without physically disabling the optical operations of the light-shielding member or without changing the structure of the light-shielding member.

In the display device according to the aspect of the invention, when a leading subpixel of a portion inside the part of the display unit in one row is the first subpixel, the image data synthesis circuit may alternately synthesize image data of the first image and image data of the second image in that order in the portion. When the leading subpixel of a portion inside the part of the display unit in one row is the second subpixel, the image data synthesis circuit may alternately synthesize image data of the second image and image data of the first image in that order in the portion.

With this configuration, in any rows, it is possible to allow the first image and the second image to be displayed in the first subpixel and the second subpixel, respectively, regardless of the shape of the part of the display unit. Therefore, in the part of the display unit, it is possible to perform directional display of the first image and the second image in different directions as a whole.

In the display device according to the aspect of the invention, the display unit may have a plurality of pixels each having three adjacent subpixels of different colors in the row direction. When a leading pixel of a portion inside the part of the display unit in one row is a pixel having the first subpixel, the second subpixel, and the first subpixel, the image data synthesis circuit may alternately synthesize image data of the first image and image data of the second image in that order in the portion. When the leading pixel of the portion inside the part of the display unit is a pixel having the second subpixel, the first subpixel, and the second subpixel, the image data synthesis circuit may alternately synthesize image data of the second image and image data of the first image in that order in the portion.

With this configuration, it is possible to allow the first image and the second image to be displayed in the first subpixel and the second subpixel, respectively, regardless of the shape of the part of the display unit, without depending on a difference in arrangement of the first subpixel and the second subpixel in each pixel. Therefore, in the part of the display unit, it is possible to perform directional display of the first image and the second image in different directions as a whole.

In the display device according to the aspect of the invention, the image data synthesis circuit may include a first circuit that synthesizes image data of the first image and image data of the second image to generate image data of the composite image to be displayed on the part of the display unit, and a second circuit that synthesizes image data of the composite image and image data of the third image to generate image data of a display image.

With this configuration, it is possible to generate image data for directional display of the first image and the second image in the part of the display unit and normal display (non-directional display) of the third image in the remaining region.

In the display device according to the aspect of the invention, the image data synthesis circuit may include a read-in control circuit that thins out image data of the first image and image data of the second image input from the outside, and stores image data in a memory with the amount of data in the column direction compressed half, and a read-out control circuit that alternately reads out and synthesizes image data of the first image and image data of the second image stored in the memory with respect to the column direction.

With this configuration, it is possible to generate image data of the composite image to be used for directional display from parts of image data of the first image and image data of the second image.

In the display device according to the aspect of the invention, the image data synthesis circuit may include a read-in control circuit that thins out image data of the first image and image data of the second image input from the outside, and stores image data in a memory with the amount of data in the row direction compressed half, and a read-out control circuit that alternately reads out and synthesizes image data of the first image and image data of the second image stored in the memory with respect to the row direction.

With this configuration, it is possible to generate image data of the composite image to be used for directional display from parts of image data of the first image and image data of the second image.

In the display device according to the aspect of the invention, the light-shielding member may be arranged in such a manner that adjacent rows are shifted by one subpixel relative to each other.

With this configuration, the light-shielding member, and the first subpixel and the second subpixel are arranged so as to have a checkered pattern. According to this arrangement, it is possible to suppress deterioration in resolution for directional display of the first image and the second image.

In the display device according to the aspect of the invention, the light-shielding member may be arranged in a stripe shape in the column direction.

With this configuration, the first subpixel and the second subpixel are also arranged in a stripe shape. According to this arrangement, it is possible to simplify the configuration of the light-shielding member.

In the display device according to the aspect of the invention, the first image may be a right-eye image, and the second image may be a left-eye image.

With this configuration, it is possible to perform stereoscopic display in the part of the display unit.

In the display device according to the aspect of the invention, the first image may be a first-viewpoint image to be observed at a first viewpoint, and the second image may be a second-viewpoint image to be observed at a second viewpoint.

With this configuration, it is possible to perform display in the part of the display unit such that images at the first viewpoint and the second viewpoint are different.

According to another aspect of the invention, an electronic apparatus includes, in a display region, the above-described display device.

With this configuration, it is possible to obtain an electronic apparatus that is capable of simultaneously perform non-directional normal display and directional display in the display region.

According to yet another aspect of the invention, there is provided an image processing method that outputs a display image to a display unit having alternately arranged a first subpixel and a second subpixel in a row direction. The method includes synthesizing image data of a first image and image data of a second image to generate image data of a composite image to be displayed on a part of the display unit; synthesizing image data of a third image to be displayed in a region excluding the part of the display unit and image data of the composite image to generate image data of the display image; and outputting image data of the first image and image data of the second image included in the display image to the first subpixel and the second subpixel arranged in the part of the display unit, respectively, and outputting image data of the third image included in the display image to the first subpixel and the second subpixel arranged in a region excluding the part of the display unit.

With this method, in the part of the display unit, it is possible to perform display of the first image by the first subpixel and display of the second image by the second subpixel. Meanwhile, in the region excluding the part of the display unit, both the first subpixel and the second subpixel display the third image. As such, according to the above-described method, it is possible to perform display suitable for directional display only in the part of the display unit.

In the image processing method according to yet another aspect of the invention, in the generating of image data of the composite image, when a leading subpixel of a portion inside the part of the display unit in one row is the first subpixel, in the portion, image data of the first image and image data of the second image may be alternately synthesized in that order. When the leading subpixel of the portion inside the part of the display unit in one row is the second subpixel, in the portion, image data of the second image and image data of the first image may be alternately synthesized in that order.

With this method, in any rows, it is possible to allow the first image and the second image to be displayed in the first subpixel and the second subpixel, respectively, regardless of the shape of the part of the display unit.

### BRIEF DESCRIPTION OF THE DRAWINGS

The invention will be described with reference to the accompanying drawings, wherein like numbers reference like elements.

FIG. 1 is a diagram showing the schematic configuration of a display device.

FIG. 2 is an enlarged plan view of a liquid crystal panel and a light-shielding member.

FIG. 3A is an enlarged plan view of a liquid crystal panel.

FIG. 3B is an enlarged plan view of a light-shielding member.

FIG. 4A is a diagram showing a directional display region and a two-dimensional display region.

FIG. 4B is an enlarged view of a region P in FIG. 4A.

FIG. 5 is a block diagram showing the overall configuration of a display device.

FIG. 6 is a block diagram showing the electrical configuration of a display unit and a peripheral driving circuit in a display device.

FIG. 7 is a schematic view illustrating an image processing method of a display device.

FIG. 8 is a schematic view showing the steps of an image processing method.

FIG. 9A is a plan view showing part of display produced using image data D in a directional display region of an image display region in a liquid crystal panel.

FIG. 9B is a plan view showing part of display produced using image data D in a directional display region of an image display region in a liquid crystal panel.

FIG. 9C is a plan view showing part of display produced using image data D in a directional display region of an image display region in a liquid crystal panel.

FIG. 10 is a block diagram showing the overall configuration of a display device according to Modification 1.

FIG. 11 is a schematic view showing the steps of an image processing method according to Modification 1.

FIG. 12 is a schematic view showing the steps of an image processing method according to Modification 2.

FIG. 13 is a schematic view showing an example of a read-out rule by a read-out control circuit according to Modification 2.

FIG. 14 is a schematic view showing the steps of an image processing method according to Modification 3.

FIG. 15 is a schematic view showing an example of a read-out rule by a read-out control circuit according to Modification 3.

FIG. 16 is an enlarged plan view of a liquid crystal panel and a light-shielding member according to Modification 4.

FIG. 17A is a plan view showing part of display produced using image data in a directional display region of an image display region in a liquid crystal panel according to Modification 4.

FIG. 17B is a plan view showing part of display produced using image data in a directional display region of an image display region in a liquid crystal panel according to Modification 4.

FIG. 17C is a plan view showing part of display produced using image data in a directional display region of an image display region in a liquid crystal panel according to Modification 4.

FIG. 18 is a schematic view showing the steps of an image processing method according to Modification 5.

FIG. 19 is a perspective view showing a cellular phone as an electronic apparatus.

### DESCRIPTION OF EXEMPLARY EMBODIMENTS

Hereinafter, an embodiment of a display device, an electronic apparatus, and an image processing method will be described with reference to the drawings. In the drawings, the dimensions or relative sizes of constituent elements have been adjusted so as to be recognizable.

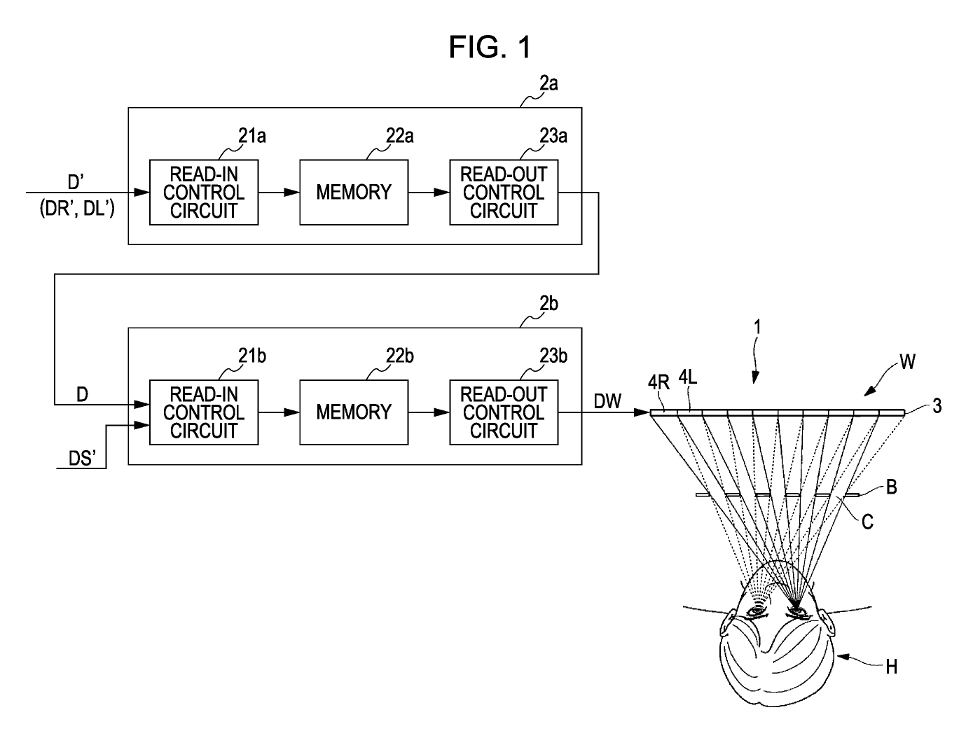

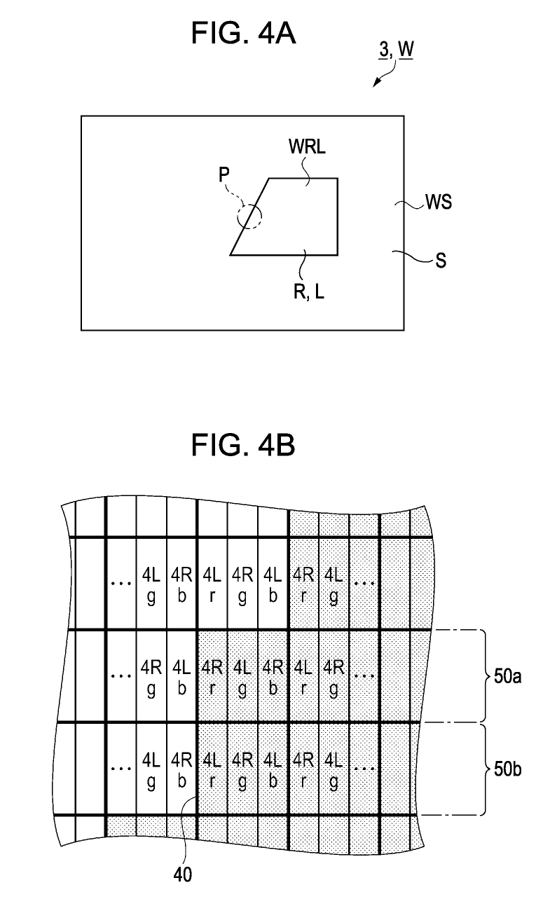

FIG. 1 is a diagram showing the schematic configuration of a display device 1. The display device 1 has image data synthesis circuits 2a and 2b, a liquid crystal panel 3, serving as a display unit, which displays image data DW output from the image data synthesis circuits 2a and 2b on an image display region W, and a light-shielding member B (a parallax barrier or an image separation unit), which spatially separates a right-eye image R and a left-eye image L displayed on the image display region W of the liquid crystal panel 3 and guides the right-eye image R and the left-eye image L to the right and left eyes of an observer H, respectively. The image data synthesis circuits 2a and 2b are shown as being separated in the drawing, but they may be collectively implemented as a single image data synthesis circuit. The image data synthesis circuits 2a and 2b correspond to a first circuit and a second circuit, respectively. The display device 1 can perform directional display of the right-eye image R and the left-eye image L in a directional display region WRL (FIG. 4A) of the image display region W in the liquid crystal panel 3, and can display a non-directional two-dimensional image S in a two-dimensional display region WS (FIG. 4A).

Multiple image data D′ including right-eye image data DR′ and left-eye image data DL′ is input to the image data synthesis circuit 2a. The image data synthesis circuit 2a synthesizes the right-eye image data DR′ and the left-eye image data DL′ to generate image data D of a composite image to be displayed in the directional display region WRL. The image data synthesis circuit 2b synthesizes image data D of the composite image and image data (two-dimensional image data DS′) of the two-dimensional image S to generate image data DW of a display image. In the above description, the right-eye image R, the left-eye image L, and the two-dimensional image S correspond to a first image, a second image, and a third image, respectively. The right-eye image data DR′ and the left-eye image data DL′ correspond to image data of the first image and image data of the second image, respectively. The two-dimensional image data DS′ corresponds to image data of the third image. The directional display region WRL corresponds to “a partial region of a display unit”, and the two-dimensional display region WS corresponds to “a region excluding the partial region of the display unit”.

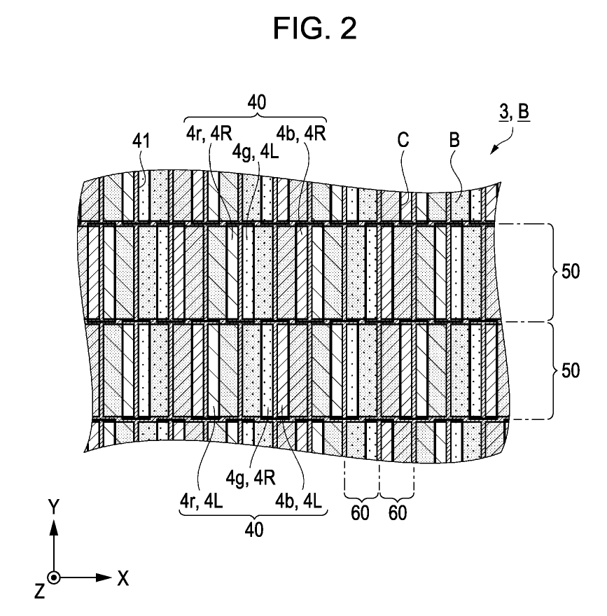

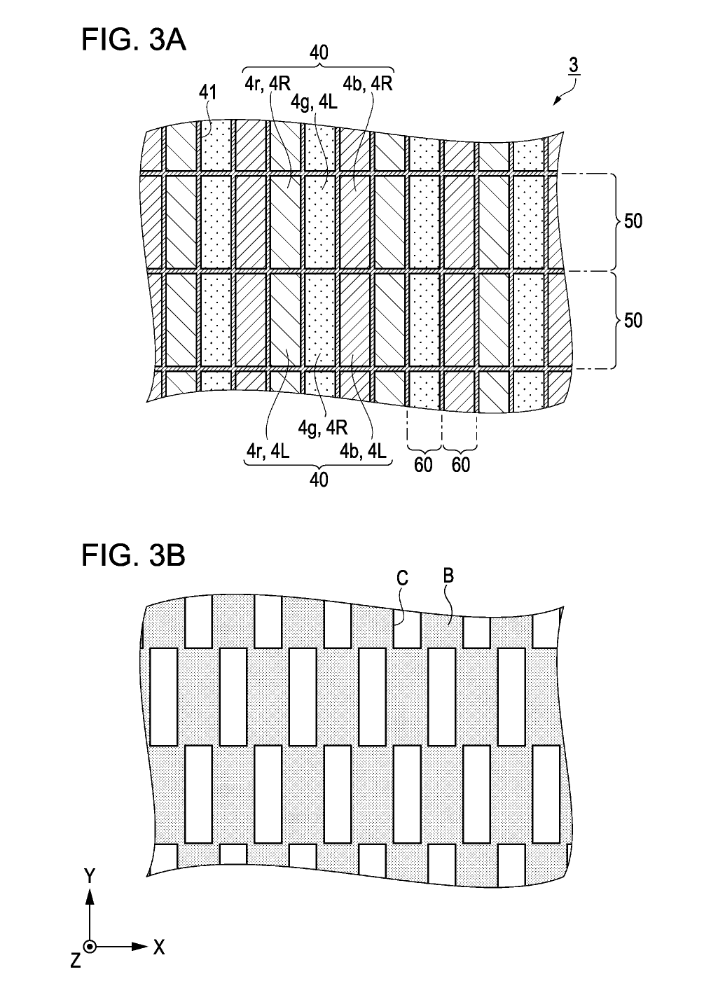

FIG. 2 is an enlarged plan view of the liquid crystal panel 3 and the light-shielding member B. FIG. 2 is a diagram showing a case in which the liquid crystal panel 3 and the light-shielding member B are viewed from a point between the eyes of the observer H. In this specification, unless otherwise noted, when each point of the display device 1 is viewed from a point on a line normal to the liquid crystal panel 3, this is called a front view. The direction normal to the liquid crystal panel 3 is defined as a Z axis. FIG. 3A is an enlarged plan view of the liquid crystal panel 3, and FIG. 3B is an enlarged plan view of the light-shielding member B. FIG. 2 is a plan view showing a state where the light-shielding member B shown in FIG. 3B is superimposed on the liquid crystal panel 3 shown in FIG. 3A.

As shown in FIG. 3A, the liquid crystal panel 3 has a plurality of subpixels 4r, 4g, and 4b that have a rectangular shape in plan view and are arranged in a matrix in a row direction and a column direction intersecting the row direction. The subpixels 4r, 4g, and 4b contribute to red, green, and blue display (hereinafter, if there is no need to discriminate between colors, the subpixels 4r, 4g, and 4b are simply called “subpixels 4”). The subpixels 4r, 4g, and 4b are repeatedly arranged in that order in the row direction and form each pixel row 50. Three adjacent subpixels 4r, 4g, and 4b in the row direction form each pixel 40. The subpixels 4 of the same color are arranged in lines in the form of stripes in the column direction to form pixel columns 60. A black matrix 41 made of light-shielding resin is arranged between adjacent subpixels 4. The region of each subpixel 4 is surrounded by the black matrix 41 in plan view. In this specification, the extension direction of each pixel row 50 is defined as an X axis, and the extension direction of each pixel column 60 is defined as a Y axis.

Each subpixel 4 corresponds to either a subpixel 4R serving as a first subpixel or a subpixel 4L serving as a second subpixel. In the directional display region WRL, the subpixel 4R displays the right-eye image R, and the subpixel 4L displays the left-eye image L. In the two-dimensional display region WS, both the subpixels 4R and 4L display the two-dimensional image S. The subpixels 4R and 4L are alternately repeatedly arranged along the pixel rows 50 and the pixel columns 60.

On an observation side of the liquid crystal panel 3, the light-shielding member B having openings C is disposed. The light-shielding member B has a light-shielding property, while light is transmitted through the openings C. Shaded portions in FIGS. 2 and 3B represent regions where the light-shielding member B is arranged. The light-shielding member B is arranged so as to overlap every other boundary of the plurality of subpixels 4 arranged in the row direction in front view. In this embodiment, the boundary region of the subpixels 4 means a region where the black matrix 41 is to be formed between adjacent subpixels 4 in the row direction.

The light-shielding member B is arranged such that an opening C is disposed in a positive X direction relative to each subpixel 4R, and is disposed in a negative X direction relative to each subpixel 4L. In other words, in plan view, the subpixel 4R is arranged at a position adjacent to one side (positive X direction) of the light-shielding member B, and the subpixel 4L is arranged at a position adjacent to the other side (negative X direction) of the light-shielding member B. As a result, with the left eye of the observer H (that is, from a direction inclined toward the positive X direction from the direction normal to the liquid crystal panel 3), the subpixel 4R is visible through the opening C, while the subpixel 4L is shielded by the light-shielding member B and is not visible. Similarly, with the left eye of the observer H (that is, from a direction inclined toward the negative X direction from the direction normal to the liquid crystal panel 3), the subpixel 4L is visible through the opening C, while the subpixel 4R is shielded by the light-shielding member B and is not visible. For this reason, display of the right-eye image R by the subpixel 4R and display of the left-eye image L by the subpixel 4L are spatially separated by the light-shielding member B. Thus, directional display of the right-eye image R and the left-eye image L in different directions is performed. In this embodiment, the right-eye image R and the left-eye image L directionally displayed in different directions are visible to the right and left eyes, respectively, thereby achieving stereoscopic display.

With respect to portions of the light-shielding member B arranged in the row direction, the light-shielding member B is arranged in such a manner that adjacent rows are shifted by one subpixel 4 relative to each other. For this reason, the light-shielding member B is arranged in a check shape or a mosaic shape so as to have a checkered pattern as a whole. With this arrangement of the light-shielding member B, it is possible to suppress deterioration in resolution of the right-eye image R and the left-eye image L.

With respect to the arrangement of the pixels 40, in this embodiment, through the relationship with the light-shielding member B, each of the pixels 40 of odd-numbered rows and odd-numbered columns includes the subpixels 4R, 4L, and 4R, and each of the pixels 40 of even-numbered rows and even-numbered columns includes the subpixels 4L, 4R, and 4L.

When both the subpixels 4R and 4L display the same image (for example, the two-dimensional image S), the same image is visible to the right and left eyes. Thus, non-directional two-dimensional display is performed. If images to be displayed in the subpixels 4R and 4L are different for every region, it is possible to enable a partial region of the display unit to perform stereoscopic display (directional display), and to enable a remaining region to perform two-dimensional display.

As shown in FIG. 4A, the display device 1 can perform directional display of the right-eye image R and the left-eye image L in the directional display region WRL of the image display region W in the liquid crystal panel 3, and can simultaneously perform non-directional display of the two-dimensional image S in the two-dimensional display region WS excluding the directional display region WRL. Hereinafter, a mechanism for performing such display and an image processing method will be described.

Returning to FIG. 1, multiple image data D′ includes right-eye image data DR′ and left-eye image data DL′. Each of right-eye image data DR′ and left-eye image data DL′ includes image data for one screen. Right-eye image data DR′ is allocated to a first half region of a data region during a predetermined period, and left-eye image data DL′ is allocated to a second half region of the data region during the predetermined region, thereby forming multiple image data D′ including image data for multiple screens.

The image data synthesis circuit 2a has a read-in control circuit 21a that compresses input multiple image data D′ and sequentially stores compressed multiple image data in a memory 22a, and a read-out control circuit 23a that reads out image data stored in the memory 22a according to a predetermined rule and outputs read image data as image data D of the composite image for one screen. The image data synthesis circuit 2a thins out parts of right-eye image data DR′ and left-eye image data DL′ included in multiple image data D′ by the read-in control circuit 21a, and alternately sorts thinned-out image data by using the memory 22a, thereby synthesizing new image data D.

Image data D that is synthesized by the image data synthesis circuit 2a is input to the image data synthesis circuit 2b. Two-dimensional image data DS′ is further input to the image data synthesis circuit 2b. Image data D and two-dimensional image data DS′ may be individually allocated to the first and second half regions of one data region in advance, like the right-eye image data DR′ and left-eye image data DL′ included in multiple image data D′.

The image data synthesis circuit 2b has a read-in control circuit 21b that compresses input image data D and two-dimensional image data DS′, and sequentially stores compressed image data in a memory 22b, and a read-out control circuit 23b that reads out image data stored in the memory 22b according to a predetermined rule, and outputs read image data as image data DW of a display image for one screen.

When it is not necessary to compress input image data D and two-dimensional image data DS′, the read-in control circuit 21b may store input data in the memory 22b as it is. Alternatively, while the read-in control circuit 21b may not be provided, image data D and two-dimensional image data DS′ input to the image data synthesis circuit 2b may be directly stored in the memory 22b.

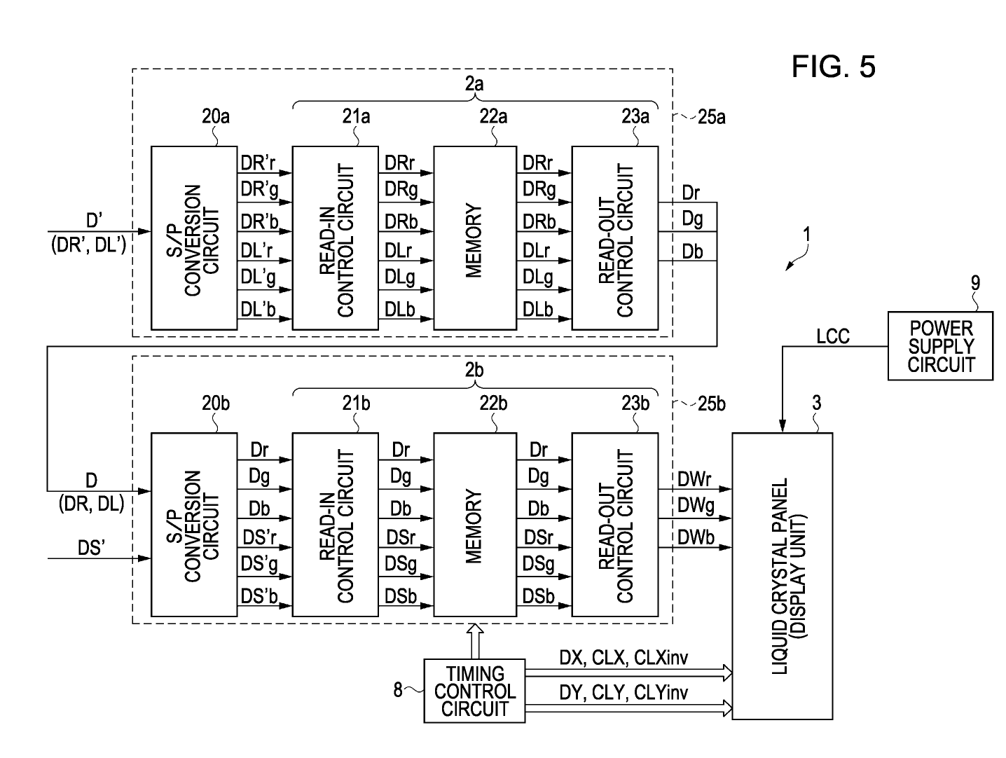

FIG. 5 is a block diagram showing the overall configuration of the display device 1. The display device 1 has a liquid crystal panel 3 serving as a display unit, image data supply circuits 25a and 25b, a timing control circuit 8, and a power supply circuit 9.

The timing control circuit 8 has a timing signal output unit (not shown) that generates a dot clock for scanning the subpixels 4 of the liquid crystal panel 3. The timing control circuit 8 generates, on the basis of the dot clock generated by the timing signal output unit, a Y clock signal CLY, an inverted Y clock signal CLYinv, an X clock signal CLX, an inverted X clock signal CLXinv, a Y start pulse DY, and an X start pulse DX, and outputs the generated signals to the image data supply circuit 25b and the liquid crystal panel 3.

The image data supply circuit 25a has an S/P conversion circuit 20a and an image data synthesis circuit 2a. The S/P conversion circuit 20a divides a series of multiple image data D′ input from the outside into right-eye image data DR′r, DR′g, and DR′b and left-eye image data DL′r, DL′g, and DL′b, and outputs the divided image data to the read-in control circuit 21a of the image data synthesis circuit 2a as six-phase image data. The read-in control circuit 21a thins out parts of six image data DR′r, DR′g, DR′b, DL′r, DL′g, and DL′b phase-expanded by the S/P conversion circuit 20a, and outputs new six image data DRr, DRg, DRb, DLr, DLg, and DLb to the memory 22a. The read-out control circuit 23a sorts image data DRr, DRg, DRb, DLr, DLg, and DLb stored in the memory 22a, and outputs image data Dr, Dg, and Db of the composite image to the image data supply circuit 25b. The suffixes “r”, “g”, and “b” denote red, green, and blue image data, respectively. Image data Dr, Dg, and Db is red, green, and blue image data individually formed by synthesizing the right-eye image R and the left-eye image L.

Similarly, the image data supply circuit 25b has an S/P conversion circuit 20b and an image data synthesis circuit 2b. The S/P conversion circuit 20b divides input image data D and two-dimensional image data DS′ into six-phase image data Dr, Dg, Db, DS′r, DS′g, and DS′b, and outputs the divided image data to the read-in control circuit 21b of the image data synthesis circuit 2b. The read-in control circuit 21b thins out six image data Dr, Dg, Db, DS′r, DS′g, and DS′b phase-expanded by the S/P conversion circuit 20b as required, and outputs new six image data Dr, Dg, Db, DSr, DSg, and DSb to the memory 22b. The read-out control circuit 23b sorts image data Dr, Dg, Db, DSr, DSg, and DSb stored in the memory 22b, and outputs image data DWr, DWg, and DWb of a display image for one screen to the liquid crystal panel 3.

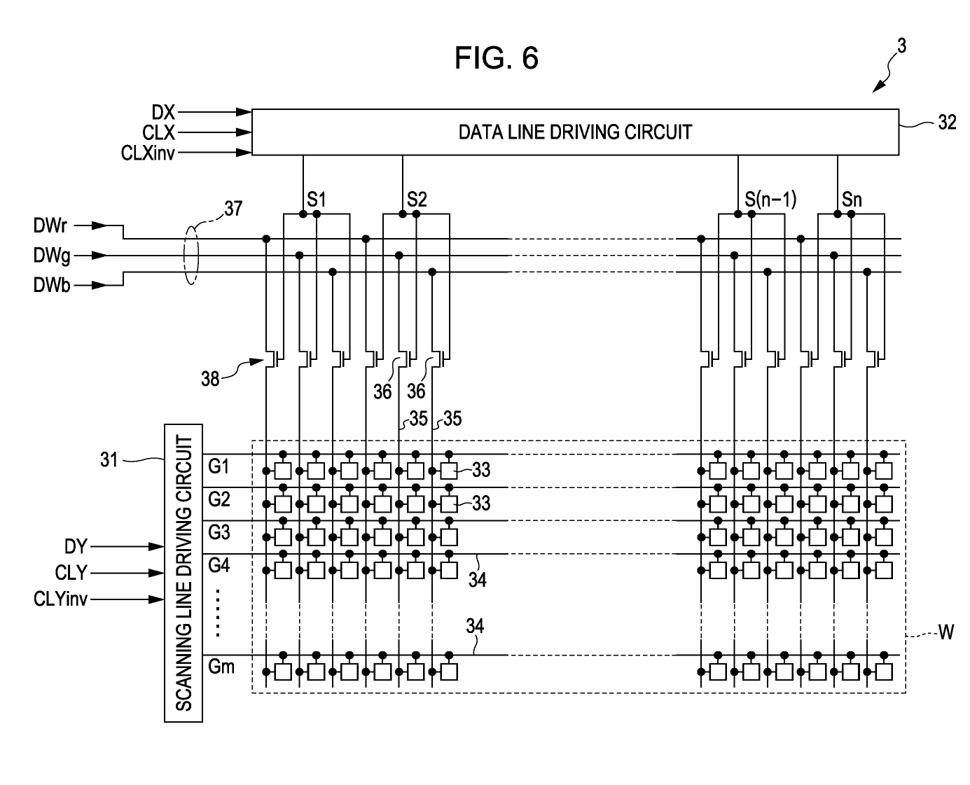

FIG. 6 is a block diagram showing the electrical configuration of the liquid crystal panel 3 and a peripheral driving circuit. The liquid crystal panel 3 is provided with the image display region (screen) W for displaying image data DWr, DWg, and DWb. In the image display region W, a plurality of pixel electrode 33 correspondingly formed in the subpixels 4 are provided in a matrix in the row direction and the column direction. At the boundaries of the pixel electrodes 33, a plurality of scanning lines 34 and a plurality of data lines 35 are provided in the row direction and the column direction of the image display region W, respectively. TFT (Thin Film Transistor) elements (not shown) serving as pixel switching elements are provided at the intersections of the scanning lines 34 and the data lines 35. The pixel electrodes 33 are correspondingly electrically connected to the scanning lines 34 and the data lines 35 through the TFTs.

A peripheral driving circuit having a scanning line driving circuit 31, a data line driving circuit 32, and a sampling circuit 38 is provided in a peripheral portion of the image display region W. These circuits may be formed on a substrate, on which the pixel electrodes 33 are formed, as a single body or may be provided separately from the substrate in the form of a driving IC.

Three image signal lines 37 for supplying image data DWr, DWg, and DWb are provided between the data line driving circuit 32 and the sampling circuit 38. The three image signal lines 37 correspond to three-phase expanded red image data DWr, green image data DWg, and blue image data DWb.

A sampling switch 36 is electrically connected to one end of a corresponding data line 35. The sampling switch 36 is electrically connected to any one of the three image signal lines 37 for supplying three-phase image data DWr, DWg, and DWb. A plurality of sampling switches 36 are provided in a horizontal direction. The plurality of sampling switches 36 forms the sampling circuit 38.

The scanning line driving circuit 31 is supplied with, from the timing control circuit 8 shown in FIG. 5, the Y clock signal CLY, the inverted Y clock signal CLYinv, and the Y start pulse DY. If the Y start pulse DY is input, the scanning line driving circuit 31 sequentially generates and outputs scanning signals G1, G2, . . . , and Gn on the basis of the Y clock signal CLY and the inverted Y clock signal CLYinv.

The data line driving circuit 32 is supplied with, from the timing control circuit 8 shown in FIG. 5, the X clock signal CLX, the inverted X clock signal CLXinv, and the X start pulse DX. If the X start pulse DX is input, the data line driving circuit 32 sequentially generates and outputs sampling signals S1, S2, . . . , and Sn on the basis of the X clock signal CLX and the inverted X clock signal CLXinv.

The sampling signals are individually supplied to the pixels 40 each having three subpixels of red, green, and blue consecutively arranged in the horizontal direction. The sampling signals S1, S2, . . . , and Sn are individually supplied to the pixels 40 from the data line driving circuit 32, and the sampling switches 36 are turned on in accordance with the sampling signals S1, S2, . . . , and Sn. Then, image data DWr, DWg, and DWb is sequentially supplied to the data lines 35 for the respective pixels 40 through the turned-on sampling switches 36.

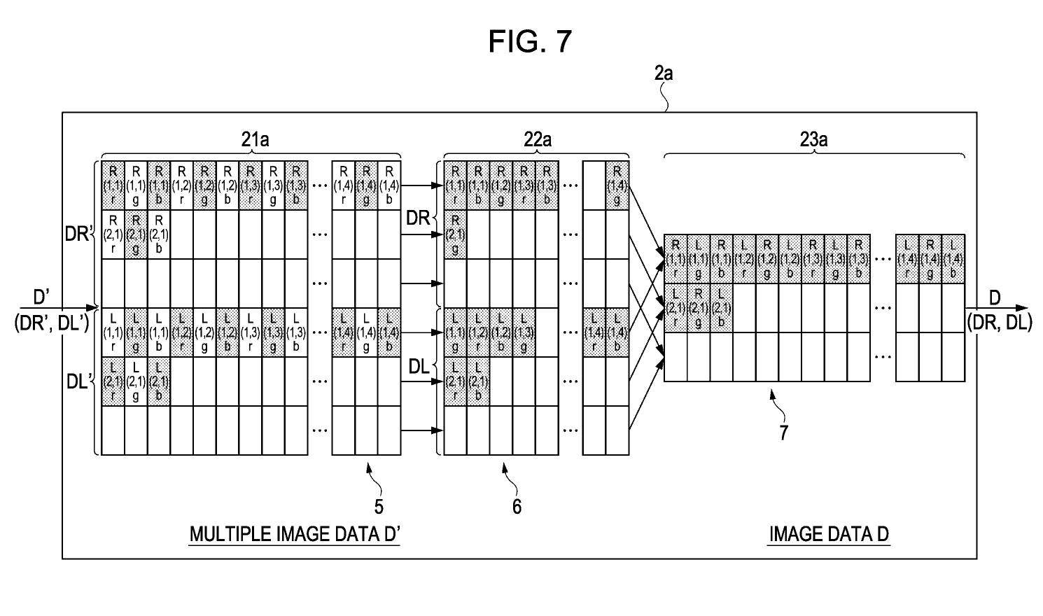

Next, an image processing method performed by the image data synthesis circuit 2a will be described in detail with reference to FIG. 7. First, the read-in control circuit 21a reads in multiple image data D′. The read-in control circuit 21a thins out parts of read-in right-eye image data DR′ and left-eye image data DL′. Next, new right-eye image data DR and left-eye image data DL that are created by thinning out parts of right-eye image data DR′ and left-eye image data DL′ are sequentially input to the memory 22a.

Multiple image data D′ includes right-eye image data DR′ for one screen to be expressed by R(1,1), R(1,2), and left-eye image data DL′ for one screen to be expressed by L(1,1), L(1,2) . . . . In FIG. 7, arrangement 5 represents the arrangement of image data for one screen of multiple image data D′ input from the outside, and arrangement 6 represents the arrangement of memory areas in the memory 22a. Arrangement 7 represents the arrangement of image data of the composite image for one screen created by selecting and sorting part of multiple image data D′. Image data D includes right-eye image data DR created by extracting part of right-eye image data DR′, and left-eye image data DL created by extracting part of left-eye image data DL′. These are sorted for the respective subpixels 4, and are then output as image data Dr, Dg, and Db of the subpixels 4r, 4g, and 4b (FIG. 5).

In the arrangement 5 and the arrangement 7, a plurality of rectangular regions individually represent image data of the subpixels 4. The characters on an upper side of each of the rectangular regions represent the type of image data (in case of the right-eye image R, the character R appears, and in case of the left-eye image L, the character L appears), and the coordinates on the image display region W of the pixel 40 including the subpixel 4. For example, image data with the characters “R(n,k)” (where n and k: natural numbers) appearing on the upper side is image data of the right-eye image R of a pixel 40 of n-th row and k-th column on the image display region W. The character on a lower side of each of the rectangular regions represent color information of each subpixel 4. The characters “r”, “g”, and “b” represent color information of red, green, and blue, respectively. For example, image data with the character “m” (m: r, g, and b) appearing on the lower side is image data of a subpixel 4 corresponding to m color. Hereinafter, image data of each subpixel 4 is specified by simply referring to information that appears on the upper side and information that appears on the lower side together, for example, “R(n,k)m” (where n and k: natural numbers, and m: r, g, and b).

The read-in control circuit 21a performs the following processing on right-eye image data DR′. With respect to the odd-numbered rows, image data having color information of green from among image data of the pixels 40 of the odd-numbered columns is thinned out, and image data having color information of red and blue from among image data of the pixels 40 of the even-numbered columns is thinned out. Remaining image data is stored in the memory 22a. For example, image data R(1,1)g of a green subpixel 4g from among image data of a pixel 40 at the coordinates (1,1) is thinned out, and image data R(1,1)r and R(1,1)b of a red subpixel 4r and a blue subpixel 4b is stored in the memory 22a. With respect to image data of a pixel 40 at the coordinates (1,2), image data R(1,2)r and R(1,2)b of a red subpixel 4r and a blue subpixel 4b is thinned out, and image data R(1,2)g of a green subpixel 4g is stored in the memory 22a. With respect to image data of a pixel 40 at the coordinates (1,3), image data R(1,3)g of a green subpixel 4g is thinned out, and image data R(1,3)r and R(1,3)b of a red subpixel 4r and a blue subpixel 4b is stored in the memory 22a.

Meanwhile, with respect to the even-numbered rows, colors corresponding to image data to be thinned out in each pixel 40 are opposite to those in the odd-numbered rows. That is, image data having color information of red and blue from among image data of the pixels 40 of the odd-numbered columns is thinned out, and image data having color information of green from among image data of the pixels 40 of the even-numbered columns is thinned out. Remaining image data is stored in the memory 22a. For example, with respect to image data of a pixel 40 at the coordinates (2,1), image data R(2,1)r and R(2,1)b of a red subpixel 4r and a blue subpixel 4b is thinned out, and image data R(2,1)g of a green subpixel 4g is stored in the memory 22a.

With respect to right-eye image data DR newly created in this way, color information of part of original right-eye image data DR′ is selected, and remaining color information is thinned out. Thus, right-eye image data DR becomes image data with the amount of information of the thinned portion compressed half.

After the image processing on right-eye image data DR′ is completed, the read-in control circuit 21a performs the following processing on left-eye image data DL′. That is, with respect to left-eye image data DL′, in a pixel 40, data corresponding to a color with no right-eye image data DR′ thinned out is thinned out. Specifically, in a pixel 40 of n-th row and k-th column, when image data R(n,k)r and R(n,k)b are not thinned out, image data L(n,k)r and L(n,k)b is thinned out. When image data R(n,k)g is not thinned out, image data L(n,k)g is thinned out.

First, with respect to the odd-numbered rows, image data having color information of red and blue from among image data of the pixels 40 of the odd-numbered columns is thinned out, and image data having color information of green from among image data of the pixels 40 of the even-numbered columns is thinned out. Remaining image data is stored in the memory 22a. For example, with respect to left-eye image data DL′, image data L(1,1)r and L(1,1)b of a red subpixel 4r and a blue subpixel 4b from among image data of a pixel 40 at the coordinates (1,1) is thinned out, image data L(1,1)g of a green subpixel 4g is stored in the memory 22a. With respect to image data of a pixel 40 at the coordinates (1,2), image data L(1,2)g of a green subpixel 4g is thinned out, and image data L(1,2)r and L(1,2)b of a red subpixel 4r and a blue subpixel 4b is stored in the memory 22a. With respect to image data of a pixel 40 at the coordinates (1,3), image data L(1,3)r and L(1,3)b of a red subpixel 4r and a blue subpixel 4b is thinned out, and image data L(1,3)g of a green subpixel 4g is stored in the memory 22a.

Meanwhile, with respect to the even-numbered rows, colors corresponding to image data to be thinned out in each pixel 40 are opposite to those in the odd-numbered rows. That is, image data having color information of green from among image data of the pixels 40 of the odd-numbered columns is thinned out, and image data having color information of red and blue from among image data of the pixels 40 of the even-numbered columns is thinned out. Remaining image data is stored in the memory 22a. For example, with respect to image data of a pixel 40 at the coordinates (2,1), image data L(2,1)g of a green subpixel 4g is thinned out, and image data L(2,1)r and L(2,1)b of a red subpixel 4r and a blue subpixel 4b is stored in the memory 22a.

With respect to left-eye image data DL newly created in this way, color information of part of original left-eye image data DL′ is selected, and remaining color information is thinned out. Thus, left-eye image data DL becomes image data with the amount of information of the thinned portion compressed half.

After the above processing is completed, the read-out control circuit 23a reads out right-eye image data DR and left-eye image data DL from the memory 22a in accordance with a predetermined rule. That is, image data R(n,k)r, L(n,k)g, and R(n,k)b are read out at positions corresponding to the subpixels 4r, 4g, and 4b in each of the pixels 40 of odd-numbered rows and odd-numbered columns or even-numbered rows and even-numbered columns. Image data L(n,k)r, R(n,k)g, and L(n,k)b are read out at positions corresponding to the subpixels 4r, 4g, and 4b in each of the pixels 40 of odd-numbered rows and even-numbered columns or even-numbered rows and odd-numbered columns. Thus, image data D of a new composite image with right-eye image data DR and left-eye image data DL synthesized is created.

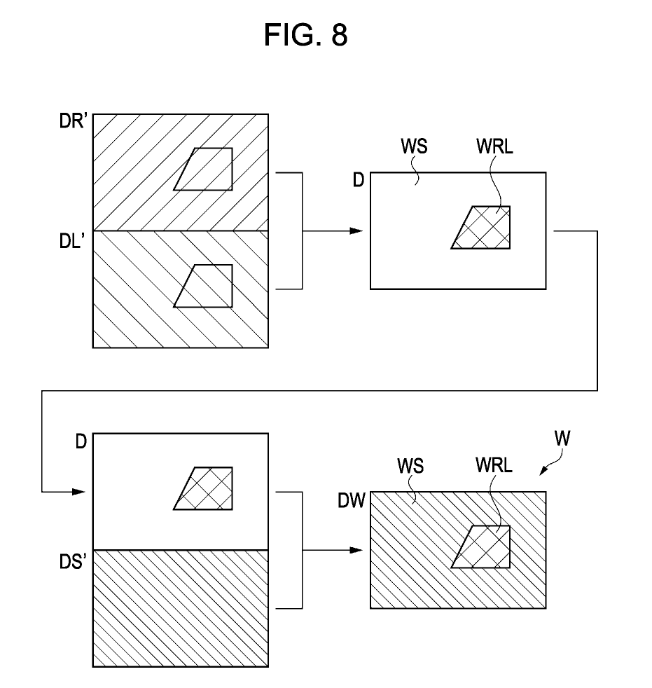

As shown in FIG. 8, the synthesis processing carried out by the image data synthesis circuit 2a is performed on at least the directional display region WRL. Such synthesis processing may be performed on the two-dimensional display region WS, and other arbitrary image data (for example, white display data or black display data) may be arranged. That is, what is necessary is that, in a region corresponding to at least the directional display region WRL, image data D of the composite image includes data with right-eye image data DR′ and left-eye image data DL′ synthesized. This is because data of a portion corresponding to the two-dimensional display region WS from among image data D of the composite image is subsequently substituted with two-dimensional image data DS due to the operations of the image data synthesis circuit 2b.

The directional display region WRL may have a trapezoidal shape or a rectangular shape as shown in FIG. 4A or may have another arbitrary shape. FIG. 4B is an enlarged view of a region P in FIG. 4A. In FIG. 4B, regions with dots attached thereto represent the directional display region WRL. As shown in FIG. 4B, a leading (left end in FIG. 4B) pixel 40 from among the pixels 40 of any row in the directional display region WRL may be formed by the subpixels 4R, 4L, and 4R or may be formed by the subpixels 4L, 4R, and 4L depending on the shape of the directional display region WRL. In the example of FIG. 4B, a leading pixel 40 in a pixel row 50a is formed by the subpixels 4R, 4L, and 4R, and a leading pixel 40 in a pixel row 50b is formed by the subpixels 4L, 4R, and 4L. In other words, in the pixel row 50a, a leading subpixel 4 is the subpixel 4R, and in the pixel row 50b, a leading subpixel 4 is the subpixel 4L.

In order to appropriately perform stereoscopic display independently of the type of a leading pixel 40 or a leading subpixel 4 in the directional display region WRL, when a leading pixel 40 of a portion inside the directional display region WRL in one row is formed by the subpixels 4R, 4L, and 4R, the image data synthesis circuit 2a alternately synthesizes right-eye image data DR′ and left-eye image data DL′ in that order in the portion. When a leading pixel 40 of a portion inside the directional display region WRL in one row is formed by the subpixels 4L, 4R, and 4L, the image data synthesis circuit 2a alternately synthesizes left-eye image data DL′ and right-eye image data DR′ in that order in the portion.

Alternatively, when a leading subpixel 4 of a portion inside the directional display region WRL in one row is the subpixel 4R, the image data synthesis circuit 2a alternately synthesizes right-eye image data DR′ and left-eye image data DL′ in that order in the portion. When a leading subpixel 4 of a portion inside the directional display region WRL in one row is the subpixel 4L, the image data synthesis circuit 2a alternately synthesizes left-eye image data DL′ and right-eye image data DR′ in that order in the portion.

In this embodiment, each of the pixels 40 of odd-numbered rows and odd-numbered columns or even-numbered rows and even-numbered columns includes the subpixels 4R, 4L, and 4R, and each of the pixels 40 of odd-numbered rows and even-numbered columns or even-numbered rows and odd-numbered columns includes the subpixels 4L, 4R, and 4L. For this reason, when a leading pixel 40 of a portion inside the directional display region WRL in one row is a pixel 40 of an odd-numbered row and an odd-numbered column or an even-numbered row and an even-numbered column, the image data synthesis circuit 2a alternately synthesizes right-eye image data DR′ and left-eye image data DL′ in that order in the portion. When a leading pixel 40 of a portion inside the directional display region WRL in one row is a pixel 40 of an odd-numbered row and an even-numbered column or an even-numbered row and an odd-numbered column, the image data synthesis circuit 2a alternately synthesizes left-eye image data DL′ and right-eye image data DR′ in that order in the portion. Such synthesis enables right-eye image data DR′ and left-eye image data DL′ to be individually allocated to the subpixels 4R and 4L independently of the shape of the directional display region WRL.

Data about the shape of the directional display region WRL or the position of the directional display region WRL inside the image display region W may have, for example, a fixed value. Alternatively, such data may be input by the observer H through an input device. Examples of the input device include a keyboard, a mouse, a touch panel, and a game pad. With this configuration, it is possible for the observer H to form the directional display region WRL as a region having a desired shape or at a desired position. Therefore, it is possible to improve operationality of the display device 1.

Image data D of the composite image obtained in this way is input to the image data supply circuit 25b, as shown in FIG. 5, and is divided into three-phase image data by the S/P conversion circuit 20b. Three-phase image data is stored in the memory 22b of the image data synthesis circuit 2b. Meanwhile, two-dimensional image data DS′ to be displayed in the two-dimensional display region WS is also input to the image data supply circuit 25b, and is divided into three-phase image data by the S/P conversion circuit 20b. Three-phase image data is stored in the memory 22b of the image data synthesis circuit 2b. In this case, when two-dimensional image data DS′ is larger in size than two-dimensional display region WS, two-dimensional image data DS′ is appropriately thinned out by the read-in control circuit 21b and is then stored in the memory 22b.

The read-out control circuit 23b reads out image data D of the composite image and two-dimensional image data DS from the memory 22b in accordance with a predetermined rule. That is, as shown in FIG. 8, with respect to a region corresponding to the directional display region WRL in the image display region W, image data D of the composite image is read out, and with respect to a region corresponding to the two-dimensional display region WS, two-dimensional image data DS′ is read out. In this way, image data DW of a display image to be used for display of the liquid crystal panel 3 is finally created.

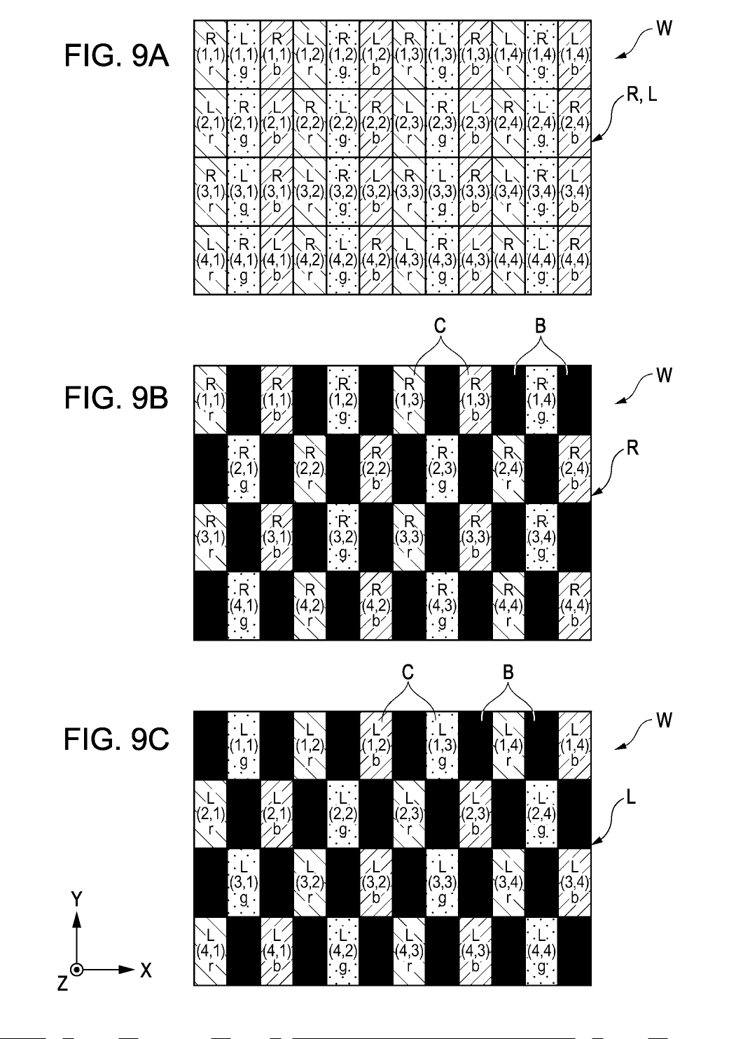

FIGS. 9A to 9C are plan views showing part of display produced using image data DW in the directional display region WRL of the image display region W in the liquid crystal panel 3. In the directional display region WRL, as described above, right-eye image data DR and left-eye image data DL are allocated to the subpixels 4R and 4L, respectively. Thus, the right-eye image R and the left-eye image L are displayed on the subpixels 4R and 4L. FIG. 9A is a plan view showing the right-eye image R and the left-eye image L when viewed with no light-shielding member B provided. In FIG. 9A, the subpixels 4R for displaying the right-eye image R and the subpixels 4L for displaying the left-eye image L are arranged in a mosaic shape so as to have a checkered pattern.

FIG. 9B is a plan view of the right-eye image R when the image display region W is viewed from the viewpoint of the right eye (that is, from the positive X direction) through the light-shielding member B. As such, through the openings C of the light-shielding member B having a checkered pattern, the right-eye image R having the same checkered pattern is observed. FIG. 9C is a plan view of the left-eye image L when the image display region W is viewed from the viewpoint of the left eye (that is, from the negative X direction) through the light-shielding member B. As such, through the openings C of the light-shielding member B having a checkered pattern, the left-eye image L having the same checkered pattern is observed. If the right-eye image R and the left-eye image L are simultaneously observed by both eyes, in the directional display region WRL, stereoscopic display can be performed.

As such, with respect to image data DW, image data D of the composite image is allocated to the directional display region WRL. Specifically, right-eye image data DR and left-eye image data DL are allocated to the subpixels 4R and 4L of the directional display region WRL, respectively. Meanwhile, in the two-dimensional display region WS, two-dimensional image data DS′ is allocated to both the subpixels 4R and 4L. Therefore, in a partial region (directional display region WRL) of the image display region W of the liquid crystal panel 3, the subpixels 4R display the right-eye image R in accordance with right-eye image data DR, and the subpixels 4L display the left-eye image L in accordance with left-eye image data DL. In a region (two-dimensional display region WS) excluding the partial region of the image display region W of the liquid crystal panel 3, the subpixels 4R and 4L display the two-dimensional image S in accordance with two-dimensional image data DS′.

Therefore, according to the configuration of the display device 1 and image data DW generated by the above-described image processing method, stereoscopic display can be performed in the directional display region WRL of the image display region W, and two-dimensional display can be performed in the remaining two-dimensional display region WS. That is, the display device 1 can perform stereoscopic display (directional display) only in the partial region of the image display region W without physically disabling the optical operations of the light-shielding member B or without changing the structure of the light-shielding member B. In addition, the display device 1 can simultaneously perform stereoscopic display and two-dimensional display in the same image display region W.

### Electronic Apparatus

The display device 1 may be used with mounted on an electronic apparatus, such as a cellular phone. FIG. 19 is a perspective view of a cellular phone 100 as an example of an electronic apparatus. The cellular phone 100 has a display region 110 and operating buttons 120. The display region 110 can perform directional display of various kinds of information including the contents input by the operating buttons 120 or incoming call information only in a partial region by the internal display device 1.

The display device 1 according to the embodiment of the invention may be used in various electronic apparatuses, such as a game machine, a monitor for a car navigation system, a mobile computer, a digital camera, a digital video camera, an in-vehicle apparatus, and an audio instrument, in addition to the cellular phone 100.

The foregoing embodiment may be modified in various ways. The following modifications may be taken into consideration. In the following modifications, parts different from the foregoing embodiment will be described, and descriptions of the same configuration, advantages, and effects as the foregoing embodiment will be omitted.

### Modification 1

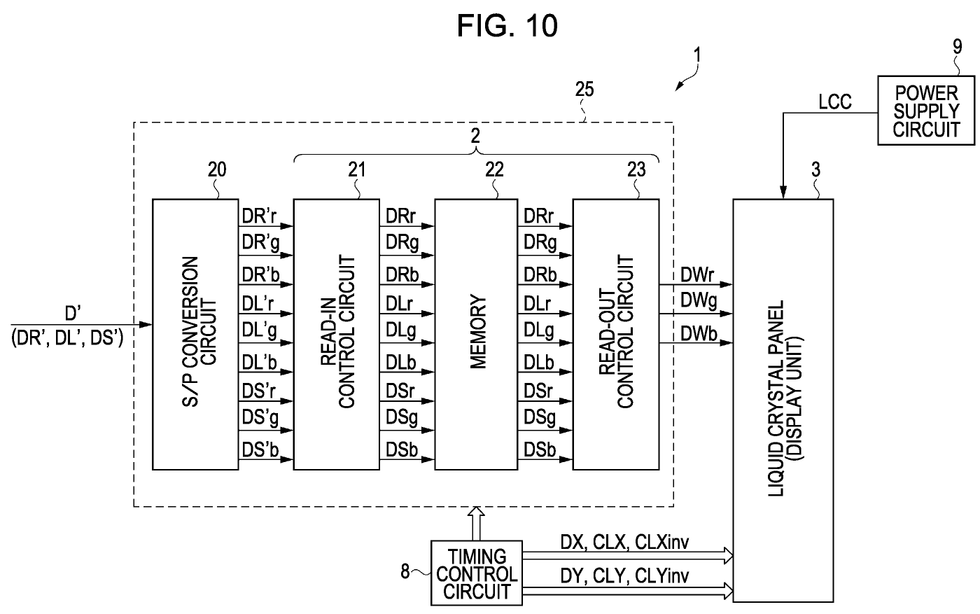

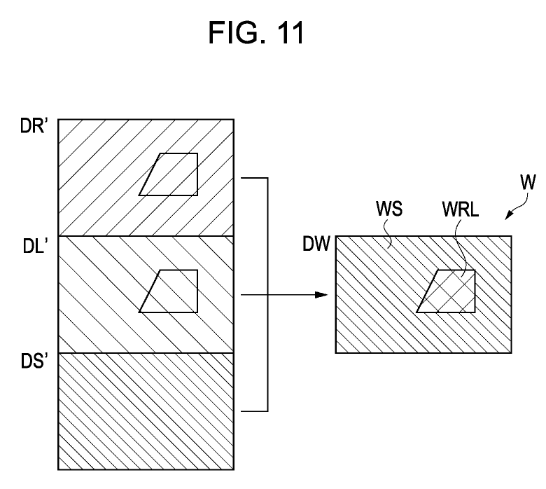

The image data synthesis circuits 2a and 2b may be functionally integrated and implemented as a single image data synthesis circuit 2. Similarly, the image data supply circuits 25a and 25b may also be integrated as a single image data supply circuit 25. FIG. 10 is a block diagram showing the overall configuration of a display device 1 according to this modification. FIG. 11 is a schematic view showing the steps of an image processing method according to this modification.

As shown in FIG. 10, the display device 1 of this modification has a single image data supply circuit 25. The image data supply circuit 25 includes an S/P conversion circuit 20 and a single image data synthesis circuit 2. Multiple image data D′ that is input to the S/P conversion circuit 20 includes right-eye image data DR′, left-eye image data DL′, and two-dimensional image data DS′. The S/P conversion circuit 20 outputs multiple image data D′ to a read-in control circuit 21 as nine-phase image data DR′r, DR′g, DR′b, DL′r, DL′g, DL′b, DS′r, DS′g, and DS′b. Nine-phase image data input to the read-in control circuit 21 is thinned out in the same manner as the foregoing embodiment, and right-eye image data DR (DRr, DRg, and DRb), left-eye image data DL (DLr, DLg, and DLb), and two-dimensional image data DS (DSr, DSg, and DSb) are output to a memory 22. A read-out control circuit 23 reads out right-eye image data DR, left-eye image data DL, and two-dimensional image data DS from the memory 22 in accordance with a predetermined rule. That is, right-eye image data DR and left-eye image data DL are read out at positions corresponding to the subpixels 4R and 4L inside the directional display region WRL, respectively, and two-dimensional image data DS is read out at positions corresponding to the subpixels 4R and 4L inside the two-dimensional display region WS. Thus, image data DW of the composite image is generated.

According to such configuration and image forming method, as shown in a schematic view of FIG. 11, it is possible to generate image data DW by synthesizing right-eye image data DR′, left-eye image data DL′, and two-dimensional image data DS′ at one time. Therefore, the configuration of the display device 1 can be simplified.

### Modification 2

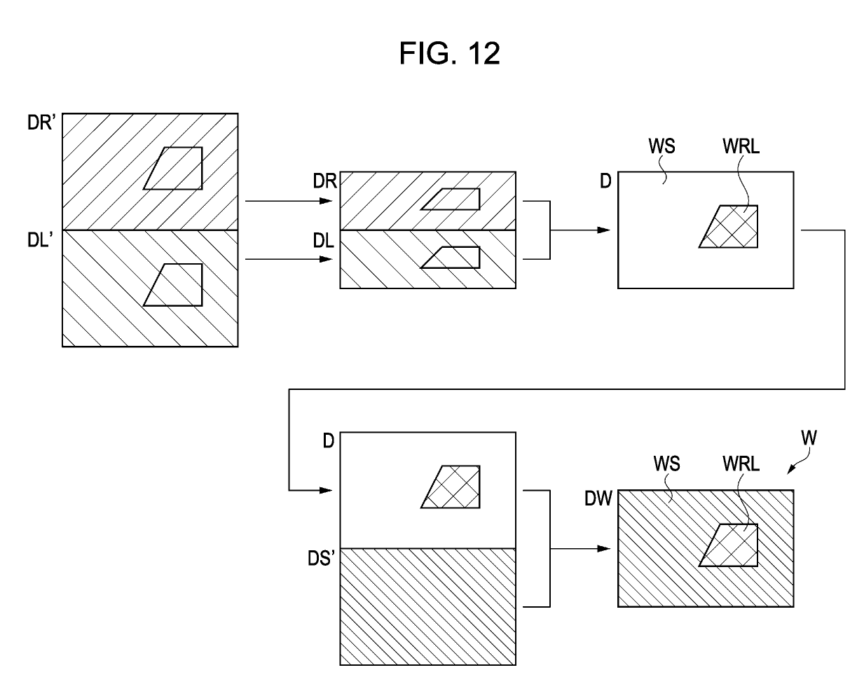

In thinning out right-eye image data DR′ and left-eye image data DL′ by using the read-in control circuit 21a, instead of the method described in the foregoing embodiment, various methods may be used. For example, as shown in FIG. 12, the read-in control circuit 21a may thin out right-eye image data DR′ and left-eye image data DL′ in the column direction, and may store image data in the memory 22a with the amount of data in the column direction compressed half. Right-eye image data DR′ and left-eye image data DL′ in FIG. 12 represent input image data, and right-eye image data DR and left-eye image data DL represent image data stored in the memory 22a after being compressed. Compression in the column direction may be performed by thinning out image data in every second row.

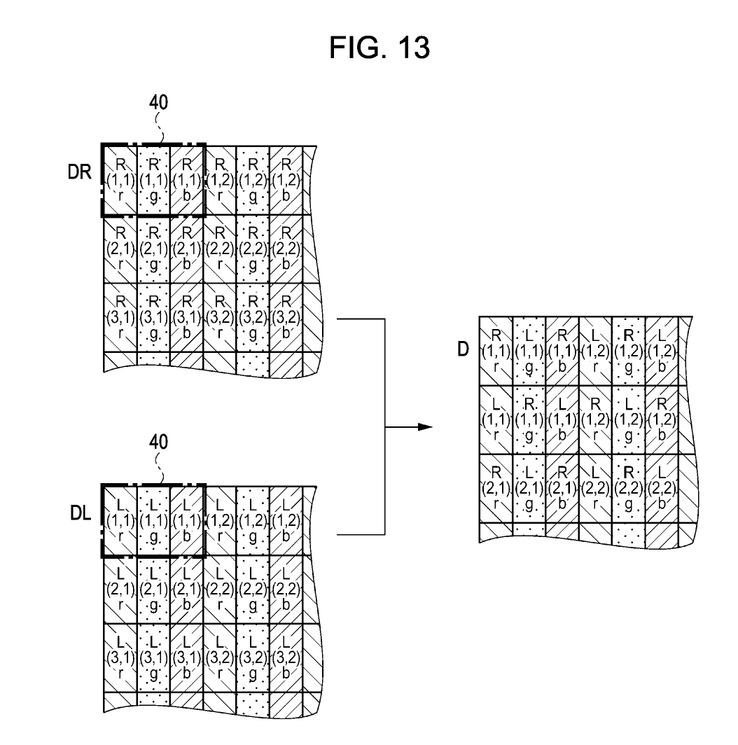

The read-out control circuit 23a reads out right-eye image data DR and left-eye image data DL, which are stored in the memory 22a with the amount of data in the column direction compressed half, according to a predetermined rule. In this case, an example of a read-out rule by the read-out control circuit 23a is shown in FIG. 13. With respect to right-eye image data DR and left-eye image data DL of FIG. 13, the numbers (n,k) of rows and columns of the pixels 40 are renewed with respect to image data after being compressed. The read-out control circuit 23a reads out image data (R(1,1)r, R(1,1)g, and R(1,1)b) of the pixel 40 at the coordinates (1,1) of right-eye image data DR, and image data (L(1,1)r, L(1,1)g, and L(1,1)b) of the pixel 40 at the coordinates (1,1) of left-eye image data DL. Then, the read-out control circuit 23a synthesizes image data of portions corresponding to the pixels 40 at the coordinates (1,1) and (2,1) from among image data D of the composite image. That is, image data R(1,1)r, L(1,1)g, and R(1,1)b are allocated to portions corresponding to the pixel 40 at the coordinates (1,1) from among image data D, and image data L(1,1)r, R(1,1)g, and L(1,1)b are allocated to portions corresponding to the pixel 40 at the coordinates (2,1) from among image data D. As such, the read-out control circuit 23a alternately reads out right-eye image data DR and left-eye image data DL stored in the memory 22a with respect to the column direction, and performs synthesis to generate image data D. As a result, it is possible to generate image data D of the composite image with the amount of data in the column direction restored at the same magnification from right-eye image data DR and left-eye image data DL with the amount of data in the column direction compressed half.

Instead of thinning out input image data by using the read-in control circuit 21a, right-eye image data DR and left-eye image data DL with the amount of data in the column direction compressed half may be prepared beforehand, and may be directly input to the read-in control circuit 21a or the memory 22a.

### Modification 3

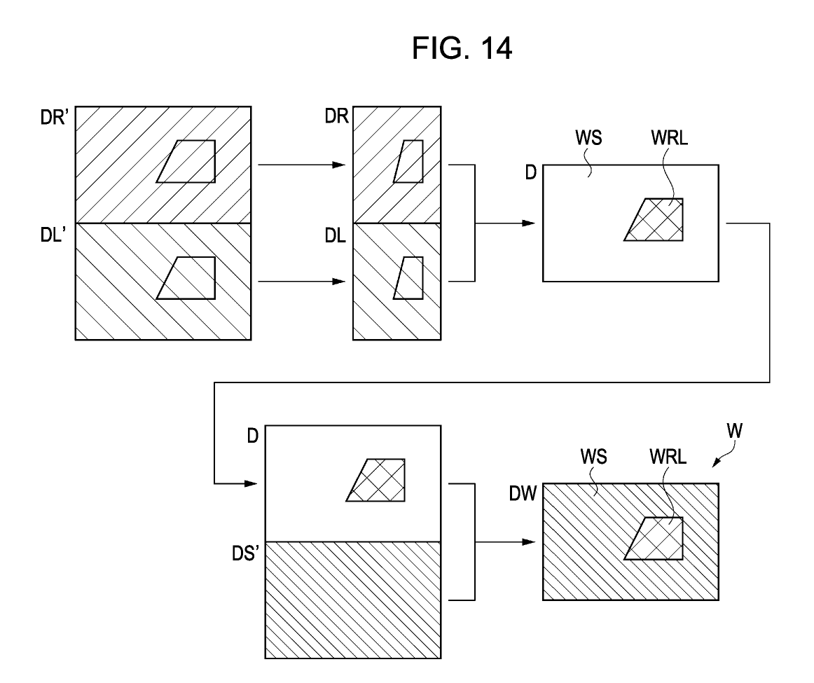

Another example of a method of thinning out right-eye image data DR′ and left-eye image data DL′ by using the read-in control circuit 21a is as follows. As shown in FIG. 14, the read-in control circuit 21a may thin out right-eye image data DR′ and left-eye image data DL′ with respect to the row direction, and may store image data in the memory 22a with the amount of data in the row direction compressed half. In FIG. 14, right-eye image data DR′ and left-eye image data DL′ represent input image data, and right-eye image data DR and left-eye image data DL represent image data stored in the memory 22a after being compressed. Compression in the row direction may be performed by thinning out image data in every second column.

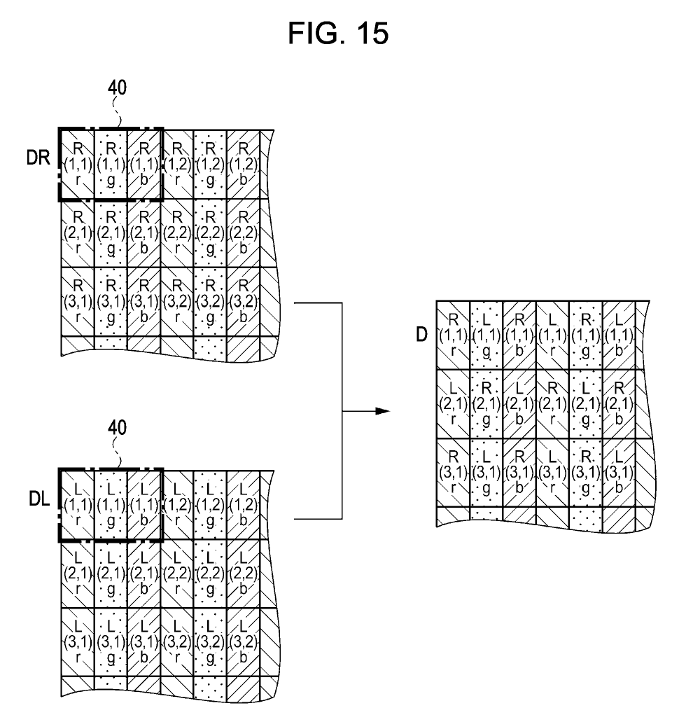

The read-out control circuit 23a reads out right-eye image data DR and left-eye image data DL, which are stored in the memory 22a with the amount of data in the row direction compressed half, according to a predetermined rule. In this case, an example of read-out rule by the read-out control circuit 23a is shown in FIG. 15. With respect to right-eye image data DR and left-eye image data DL of FIG. 15, the numbers (n,k) of rows and columns of the pixels 40 are renewed with respect to image data after being compressed. The read-out control circuit 23a reads out image data (R(1,1)r, R(1,1)g, and R(1,1)b) of the pixel 40 at the coordinates (1,1) of right-eye image data DR, and image data (L(1,1)r, L(1,1)g, and L(1,1)b) of the pixel 40 at the coordinates (1,1) of left-eye image data DL. Then, the read-out control circuit 23a synthesizes image data of portions corresponding to the pixels 40 at the coordinates (1,1) and (1,2) from among image data D of the composite image. That is, image data R(1,1)r, L(1,1)g, and R(1,1)b are allocated to portions corresponding to the pixel 40 at the coordinates (1,1) from among image data D, and image data L(1,1)r, R(1,1)g, and L(1,1)b are allocated to portions corresponding to the pixel 40 at the coordinates (1,2) from among image data D. As such, the read-out control circuit 23a alternately reads out right-eye image data DR and left-eye image data DL stored in the memory 22a with respect to the row direction, and performs synthesizes to generate image data D. As a result, it is possible to generate image data D of the composite image with the amount of data in the row direction restored at the same magnification from right-eye image data DR and left-eye image data DL with the amount of data in the row direction compressed half.

Instead of thinning out input image data by using the read-in control circuit 21a, right-eye image data DR and left-eye image data DL with the amount of data in the row direction compressed half may be prepared beforehand, and may be directly input to the read-in control circuit 21a or the memory 22a.

### Modification 4

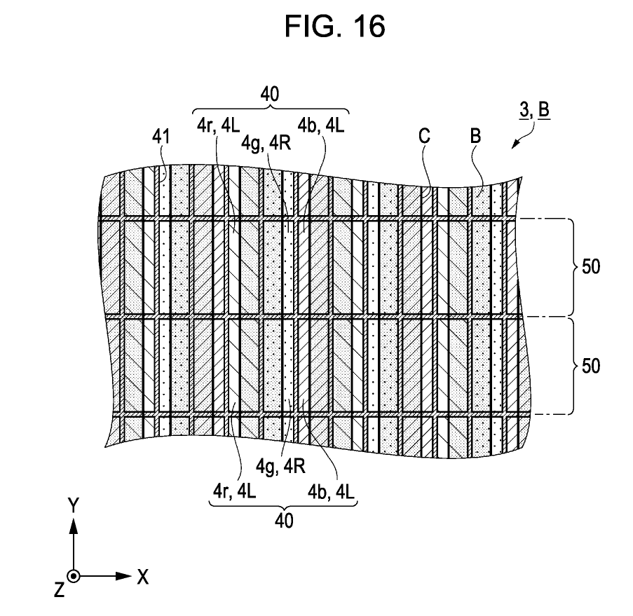

The light-shielding member B may be arranged in a stripe shape in the column direction. FIG. 16 is an enlarged plan view of a liquid crystal panel 3 and a light-shielding member B according to this modification. In this case, the openings C provided in the light-shielding member B also have a stripe shape. With respect to the subpixels 4R and 4L, the subpixels 4R and 4L of the same kind are arranged in the column direction. With this arrangement, it is possible to simplify the configuration of the light-shielding member B.

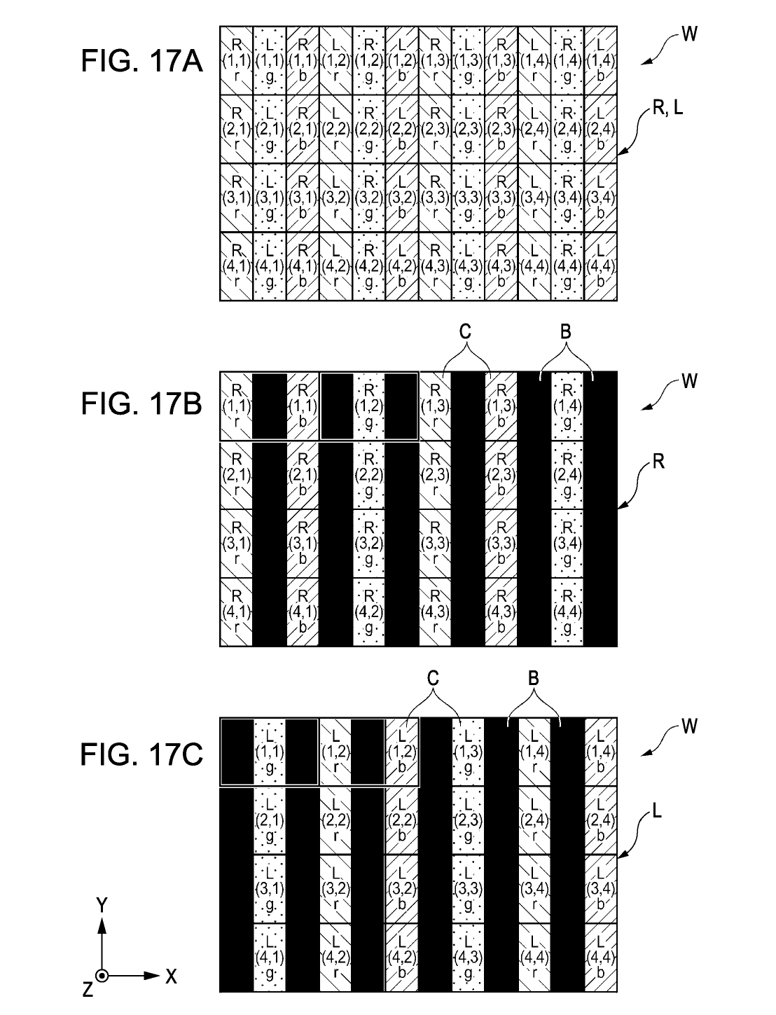

FIGS. 17A to 17C are plan views showing part of display produced using image data DW in the directional display region WRL of the image display region W in the liquid crystal panel 3. FIG. 17A is a plan view showing the right-eye image R and the left-eye image L when viewed with no light-shielding member B. As such, the subpixels 4R for displaying the right-eye image R and the subpixels 4L for displaying the left-eye image L are arranged in a stripe shape.

FIG. 17B is a plan view of the right-eye image R when the image display region W is viewed from the viewpoint of the right eye (that is, from the positive X direction) through the light-shielding member B. As such, through the openings C of the light-shielding member B having a stripe shape, the right-eye image R having the same stripe shape is observed. FIG. 17C is a plan view of the left-eye image L when the image display region W is viewed from the viewpoint of the left eye (that is, the negative X direction) through the light-shielding member B. As such, through the openings C of the light-shielding member B having a stripe shape, the left-eye image L having the same stripe shape is observed. If the right-eye image R and the left-eye image L are simultaneously observed by both eyes, in the directional display region WRL, stereoscopic display can be performed.

### Modification 5

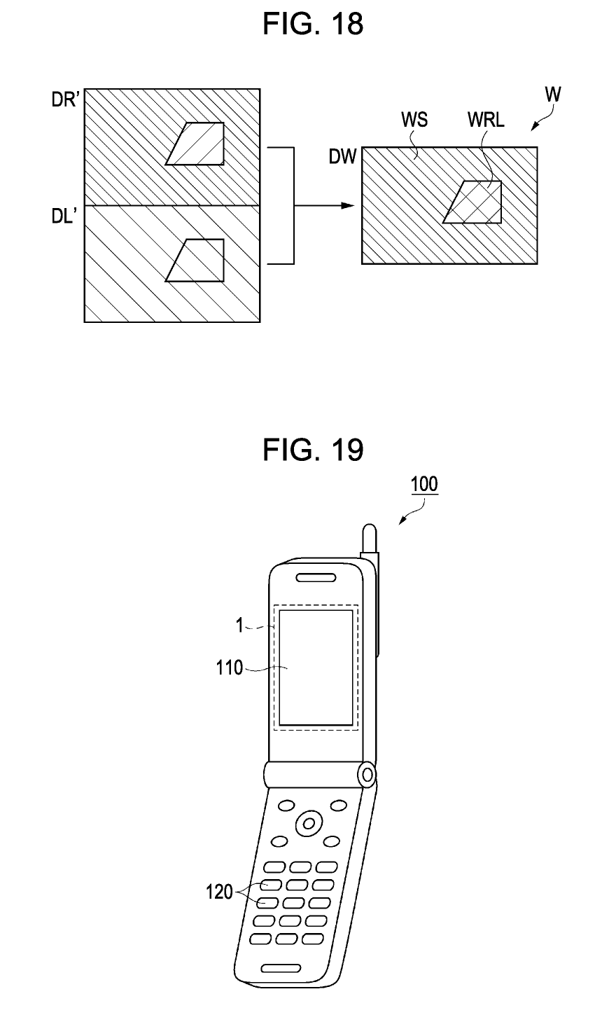

Data to be included in two-dimensional image data DS′ may be incorporated beforehand into at least one of right-eye image data DR′ and left-eye image data DL′. For example, as shown in FIG. 18, two-dimensional image data DS′ may be partially incorporated beforehand into right-eye image data DR′. In this case, image data corresponding to the directional display region WRL from among image data DW of the display image is generated from right-eye image data DR′ and left-eye image data DL′. With respect to image data corresponding to the two-dimensional display region WS, two-dimensional image data DS′ stored in a region corresponding to the two-dimensional display region WS of right-eye image data DR′ may be used. In this way, it is possible to directly generate image data DW of the display image from two image data, that is, right-eye image data DR′ and left-eye image data DL′.

### Modification 6

The display device 1 may display a multi-viewpoint image to a plurality of observers by using a part of the display unit, instead of performing stereoscopic display by using the part of the display unit. For example, image data of a first-viewpoint image to be observed at a first viewpoint may be used instead of right-eye image data DR′, and image data of a second-viewpoint image to be observed at a second viewpoint may be used instead of left-eye image data DL′. In this way, different images may be displayed on the part of the display unit at different viewpoints. With this configuration, it is possible to perform display by using the part of the display unit such that images at the first and second viewpoints are different. According to this modification, it is necessary to make the display direction of the first-viewpoint image (first image) and the display direction of the second-viewpoint image (second image) significantly different. In this case, what is necessary is to reduce the distance between the display unit (liquid crystal panel 3) and the light-shielding member B.

### Modification 7

As the display unit, in addition to the liquid crystal panel 3, various display panels, such as an organic EL (Electro Luminescence) device, a PDP (Plasma Display Panel), an SED (Surface-conduction Electron-emitter Display) an FED (Field Emission Display), and an electrophoretic display device, may be used.

### Modification 8

Although in the above description, the term “front view” refers to when each point of the display device 1 is viewed from a point on the line normal to the liquid crystal panel 3, the term “front view” may refer to when each point of the liquid crystal panel 3 is viewed from the line normal to the corresponding point.

What is claimed is:

1. A display device comprising:
a display unit that has a plurality of subpixels arranged in a row direction and a column direction intersecting the row direction;
a light-shielding member that is arranged so as to overlap every other boundary of the plurality of subpixels arranged in the row direction in front view; and
an image data synthesis circuit that synthesizes image data of a first image and image data of a second image to generate image data of a composite image to be displayed on a part of the display unit,
wherein each of the subpixels forms one of a first subpixel and a second subpixel alternately arranged in the row direction,
the first subpixel is arranged at a position adjacent to one side of the light-shielding member in front view, and the second subpixel is arranged at a position adjacent to the other side of the light-shielding member in front view,
in the part of the display unit, the first subpixel displays the first image on the basis of image data of the composite image, and the second subpixel displays the second image on the basis of image data of the composite image, and
in a region excluding the part of the display unit, the first subpixel and the second subpixel display a third image.

2. The display device according to claim 1,
wherein, when a leading subpixel of a portion inside the part of the display unit in one row is the first subpixel, the image data synthesis circuit alternately synthesizes image data of the first image and image data of the second image in that order in the portion, and
when the leading subpixel of the portion inside the part of the display unit in one row is the second subpixel, the image data synthesis circuit alternately synthesizes image data of the second image and image data of the first image in that order in the portion.

3. The display device according to claim 1,
wherein the display unit has a plurality of pixels each having three adjacent subpixels of different colors in the row direction,
when a leading pixel of a portion inside the part of the display unit in one row is a pixel having the first subpixel, the second subpixel, and the first subpixel, the image data synthesis circuit alternately synthesizes image data of the first image and image data of the second image in that order in the portion, and
when the leading pixel of the portion inside the part of the display unit is a pixel having the second subpixel, the first subpixel, and the second subpixel, the image data synthesis circuit alternately synthesizes image data of the second image and image data of the first image in that order in the portion.

4. The display device according to claim 1,
wherein the image data synthesis circuit includes
a first circuit that synthesizes image data of the first image and image data of the second image to generate image data of the composite image to be displayed on the part of the display unit, and
a second circuit that synthesizes image data of the composite image and image data of the third image to generate image data of a display image.

5. The display device according to claim 1,
wherein the image data synthesis circuit includes
a read-in control circuit that thins out image data of the first image and image data of the second image input from the outside, and stores image data in a memory with the amount of data in the column direction compressed half, and
a read-out control circuit that alternately reads out and synthesizes image data of the first image and image data of the second image stored in the memory with respect to the column direction.

6. The display device according to claim 1,
wherein the image data synthesis circuit includes
a read-in control circuit that thins out image data of the first image and image data of the second image input from the outside, and stores image data in a memory with the amount of data in the row direction compressed half, and
a read-out control circuit that alternately reads out and synthesizes image data of the first image and image data of the second image stored in the memory with respect to the row direction.

7. The display device according to claim 1,
wherein the light-shielding member is arranged in such a manner that adjacent rows are shifted by one subpixel relative to each other.

8. The display device according to claim 1,
wherein the light-shielding member is arranged in a stripe shape in the column direction.

9. The display device according to claim 1,
wherein the first image is a right-eye image, and the second image is a left-eye image.

10. The display device according to claim 1,
wherein the first image is a first-viewpoint image to be observed at a first viewpoint, and the second image is a second-viewpoint image to be observed at a second viewpoint.

11. An electronic apparatus comprising, in a display region, the display device according to claim 1.

12. An image processing method that outputs a display image to a display unit having alternately arranged a first subpixel and a second subpixel in a row direction, the method comprising:
synthesizing image data of a first image and image data of a second image to generate image data of a composite image to be displayed on a part of the display unit;
synthesizing image data of a third image to be displayed in a region excluding the part of the display unit and image data of the composite image to generate image data of the display image;
outputting image data of the first image and image data of the second image included in the display image to the first subpixel and the second subpixel arranged in the part of the display unit, respectively, and outputting image data of the third image included in the display image to the first subpixel and the second subpixel arranged in a region excluding the part of the display unit.

13. The method according to claim 12,
wherein in the generating of image data of the composite image, when a leading subpixel of a portion inside the part of the display unit in one row is the first subpixel, in the portion, image data of the first image and image data of the second image are alternately synthesized in that order, and
when the leading subpixel of the portion inside the part of the display unit in one row is the second subpixel, in the portion, image data of the second image and image data of the first image are alternately synthesized in that order.
